(19) United States
(12) Patent Application Publication
(10) Pub. No.: US 2004/0181431 A1
(43) Pub. Date: Sep. 16, 2004

(54) Device for generating standardized medical findings

(76) Inventors: Rainer Kuth, Herzogenaurach (DE); Christoph Zindel, Uttenreuth (DE)

Correspondence Address: SCHIFF HARDIN, LLP, PATENT DEPARTMENT, 6600 SEARS TOWER, CHICAGO, IL, 60606-6473, US

(21) Appl. No.: 10/740,257

(22) Filed: Dec. 18, 2003

(30) Foreign Application Priority Data
Dec. 18, 2002 (DE) 10259316.7

(51) Int. Cl. G06F 17/60

(52) U.S. Cl. 705/2

(57) ABSTRACT

A device for standardized and digitized generation of medical findings has an evaluation system, with a databank with evaluation parameters and (tentative) diagnoses, as well as an input device for the evaluation data and a monitor to display the evaluation parameters. The device suggests to the doctor a differentiation of the examination dependent on the previously entered evaluation parameters. For evaluation of clinical images that have been generated by an imaging modality, the evaluation parameters are stored in the databank sorted hierarchically and according to anatomical localization. The databank contains anatomical localization images. The evaluation system has a graphical interface for retrieving anatomical localization images from the databank for display thereof on the monitor, and for entry of subject-sensitive properties of the evaluation; and with which the anatomical details of the respective localization images can be retrieved from the databank.

### BACKGROUND OF THE INVENTION

1. Field of the Invention

The present invention concerns a device for standardized and digitized generation of medical findings of the type having an evaluation system, a databank with evaluation parameters and tentative diagnoses, as well as an input device for the evaluation data and a monitor to display the evaluation parameters, that suggest to the doctor a differentiation of the examination dependent on the previously entered evaluation parameters.

2. Description of the Prior Art

At the end of each medical examination based on images of a patient, the examining doctor writes a report in which all deviations from the norm are descriptively specified. Such a report includes, for example, a specification of the anatomical localization, the number and dimension of any lesions, its contrast and, as the case may be, its contrast agent behavior in the dynamic image. The anatomy of the body is highly complex, and diseases of all types must for this reason be systematized. For each possible deviation from the normal state, there are corresponding descriptions that are derived from the subject-specific medical nomenclature. At first, the number of possible parameters to describe a pathology is very large. Corresponding to the experience of the examiner, there is a risk of not considering, or completely forgetting, specific parameters in the evaluation that describe a pathology. The fastest possible report transmission (doctor letter) is also important. Frequently, such letters are first dictated, and must then be transcribed and mailed.

Such a device is known from European Application 1 011 419, which is concerned with the special guidance of the sequence of an examination, and not so much with the generation of a specific finding, but rather more with the generation of an overall medical protocol with diagnoses and therapy suggestions. An evaluation of the diagnoses is undertaken as well, in order to ultimately arrive at a particular result by means of a calculation.

This known method system assumes that the evaluation is simple and unambiguous, and that only the evaluation of the findings requires support with regard to the diagnosis to be applied.

In practice, however, particularly in the evaluation of clinical images generated by an imaging modality, the evaluation is already relatively complicated, and the risk also exists that experts (for example radiologists) in the evaluation may overlook certain points in medical images that may be of significant importance for a subsequent diagnosis and treatment.

### SUMMARY OF THE INVENTION

An object of the present invention is to provide a device which ensures that a doctor does not overlook substantial parameters in the evaluation of clinical images, and with which at the same time a standardized finding generation can ensue.

This object is achieved in accordance with the invention by a device of the type initially described wherein, for evaluation of clinical images that have been generated by means of an imaging modality, the evaluation parameters are sorted hierarchically and according to anatomical localization for storage in the databank, such that the databank contains anatomical localization images; and the evaluation system has a graphical interface for retrieving anatomical localization images from the databank for display thereof on the monitor, and for entry of subject-sensitive properties of the evaluation; so the anatomical details of the respective localization images can be retrieved from the databank.

The invention, which makes use of substantial features of systems known as expert systems (also known as neural networks or artificial intelligence systems), has, however, a completely different starting point than the known expert systems. In such known systems, the result of an evaluation is checked and evaluated with regard to a diagnosis using medical rules and associated medical databanks. How the finding was generated, and whether something was possibly overlooked, can neither be determined nor, if necessary, corrected in such known expert systems.

The inventive starting point is now completely different, in that, starting from a first partial (tentative) evaluation (for example the specification by the doctor, “tumor-like swelling in the large intestine”), the inventive system automatically generates a hierarchically structured parameter group and presents a display (on a monitor) to the evaluating doctor as to which steps are henceforth reasonably implementable, and in which sequence for further clarification of this first finding. The result of the evaluation of the first tentative evaluation will most likely produce further changed parameter sets, so the doctor responsible for making a finding is guided step by step, and without the danger of forgetting any substantial individual examinations, to a result that, naturally, does not have to be a final evaluation result. As appropriate, the result may be a proposal for one or more further specific examinations (magnetic resonance tomography, contrast agent x-ray examination or the like) in a particular laboratory or hospital.

In an embodiment of the invention the anatomical localization images can be locally controlled on the screen by a stylus, mouse or the like for entering findings, and a set of context-dependent and object-oriented parameters corresponding to the localization is made available from the databank that allows a standardized description of the finding.

The system is able to display a graphic representation of the anatomy of a particular body part and, depending on the imaging modality (CT, MR, x-ray, scintigram, etc.) and anatomy (body, head, thyroid, knee joint, hands, etc.) of the actual clinical image, the anatomical details of the respective representation are specified by the system.

The graphical entry (for example mouse-aided entry) of findings of the examined body region is particularly simple. Corresponding to the localization, for example the sigmoid part of the colon, the system provides a series of context-dependent parameters that allow the description of the finding, for example that it concerns a polyp whose shape, size surface aspect and so forth can be entered as additional finding data, as well as, if warranted, its recognizable malignance, whereupon a further parameter set is provided by the inventive system for more precise description of the recognized finding, or to promote additional examinations.

An important feature of the inventive system is thereby not the fact that a diagnosis is automatically made by an expert system from specific evaluation data, but rather that, with the entry of each new individual evaluation, a parameter set based thereon is made available in order to be able to either further describe the evaluation in detail, or to implement additional examinations of the patient.

In a further embodiment of the invention, medical dictionaries are associated with the databank, and an evaluation unit generates a medical report with doctor-specific or assignment-specific finding text. Such a computer-aided evaluation system ensures the generation of standardized findings that can then be evaluated in a significantly simpler manner (given the mailing to other doctors, clinics or the like) compared to manually produced reports, which sometimes are written in a somewhat idiosyncratic or opinionated manner.

The inventive device represents the parameters for a follow-up in a hierarchical manner, and preferably offers a user interface that facilitates a simple comparison of the changed findings with the older findings. This can, for example, be achieved in that the older finding is placed opposite the current finding.

In an embodiment of the invention, the device additionally has an evaluation unit that, in addition to generating an extensive report with all finding details, also generates a delta report in which only the differences between findings made at different times are shown.

Of particular importance is an embodiment of the inventive system that ensures minimum requirements for the detail of the evaluation according to standardized guidelines, such as, for example, the guidelines of a medical organization (company of firm) or the quality guidelines of the Association of CHI Physicians. This safeguard with regard to the minimum requirements for the detail of the evaluation also enables, in a simple manner, an automatic accounting (invoicing) with an accounting unit for charging for the respective medical services, which only releases the accounting result given proper evaluation according to specification standards.

### DESCRIPTION OF THE DRAWINGS

FIG. 1 schematically illustrates an inventive device.

FIGS. 2 through 9 illustrate the workflow in an inventive device with imaging diagnostics in various medical application cases.

FIG. 10 schematically illustrates the library with subject terms using the exemplary embodiment “Appendix”.

### DESCRIPTION OF THE PREFERRED EMBODIMENTS

The inventive method is first explained in detail using a simple example of a patient examination in the framework of a preventative examination:

Patient X comes to the general practitioner for a preventative examination. For this, a series of standard examinations are provided; these are marked by the following template.

Patient X

```
^{L} preventative examination
    ^{L} anamnesis [medical history]
    ^{L} urine examination
    ^{L} ultrasound examination
    ^{L} . . .
```

The general practitioner begins with the anamnesis and questions the patient about, among other things, diseases of relatives. Patient X informs the practitioner of colon cancer in his mother. During the anamnesis, the general practitioner receives the following provided menu:

Patient X

```
^{L} preventative examination
    ^{L} anamnesis
        ^{L} cancer in relatives?
            ^{L} mother?
            ^{L} father?
            ^{L} siblings?
        ^{L} acute symptoms
```

L_{urine examination}

L_{ultrasound examination}

The anamnesis thus includes two parts: the inquiry about cancer in relatives as well as the inquiry about acute symptoms.

The patient X states in this example that the mother had cancer, the general practitioner clicks on this line and receives a sub-menu of the relevant (thus genetic) cancer types for the anamnesis. Cancer types, which are caused by other influences, for example asbestos and lung cancer, do not belong to this group of types.

Patient X

```
^{L} preventative examination
    ^{L} anamnesis
        ^{L} cancer in relatives?
            ^{L} mother?
^{L} breast cancer
^{L} cervical cancer
^{L} colon cancer
^{L} bladder cancer [cystic carcinoma]
            ^{L} father?
```

The general practitioner asks the patient about the type of cancer and correspondingly clicks on colon cancer. The general practitioner immediately receives the following:

Patient X

```
^{L} preventative examination
    ^{L} anamnesis
        ^{L} cancer in relatives?
            ^{L} mother?
^{L} breast cancer
^{L} cervical cancer
^{L} colon cancer
    ^{L} hemocul test
^{L} bladder cancer
```

The patient provides first and second stool samples, and the results are in turn drawn in the template:

Patient X

```
^{L} preventative examination
    ^{L} anamnesis
        ^{L} cancer in relatives?
            ^{L} mother?
^{L} breast cancer
^{L} cervical cancer
^{L} colon cancer
    ^{L} hemocul test
        ^{L} result of test 1
        ^{L} result of test 2
        ^{L} summary: positive
^{L} bladder cancer
        ^{L} father?
        ^{L} siblings?
    ^{L} acute symptoms
^{L} urine examination
^{L} ultrasound examination
^{L} . . .
```

Based on the positive result, the patient is admitted to a clinic for precise examination:

```
^{L} preventative examination
^{L} anamnesis
    ^{L} cancer in relatives?
        ^{L} mother?
            ^{L} breast cancer
            ^{L} cervical cancer
            ^{L} colon cancer
                ^{L} hemocul test
                    ^{L} result of test 1
                    ^{L} result of test 2
                    ^{L} summary: positive
                        ^{L} clinical examination
                            ^{L} laboratory
                                ^{L} erythrocytes
                                ^{L} HB
                                ^{L} HK
                                ^{L} . . .
                            ^{L} virtual endoscopy
                            ^{L} MR measurement
                                ^{L} localizer
                            ^{L} 3D measurement
            ^{L} bladder cancer
        ^{L} father?
        ^{L} siblings?
    ^{L} acute symptoms
^{L} urine examination
^{L} ultrasound examination
```

These data are transmitted to the radiologist; the radiologist evaluates the 3D data:

```
^{L} preventative examination
    ^{L} anamnesis
        ^{L} cancer in relatives?
            ^{L} mother?
                ^{L} breast cancer
                ^{L} cervical cancer
                ^{L} colon cancer
                    ^{L} hemocul test
                        ^{L} result of test 1
                        ^{L} result of test 2
                        ^{L} summary: positive
                            ^{L} clinical examination
                                ^{L} laboratory
                                    ^{L} erythrocytes
                                        ^{L} HB
                                        ^{L} HK
                                        ^{L} . . .
                                    ^{L} virtual endoscopy
                                      ^{L} MR measurement
                                            ^{L} localizer
                                        ^{L} 3D measurement
                                        ^{L} virtual flythrough
                                        ^{L} check for polyps
                                          ^{L} polyp 1
                                            ^{L} location 1
                                              ^{L} size
                                                ^{L} shape
                                        ^{L} polyp 2
                                            ^{L} location 2
                                              ^{L} size
                                              ^{L} shape
            ^{L} bladder cancer
        ^{L} father?
        ^{L} siblings?
    ^{L} acute symptoms
^{L} urine examination
```

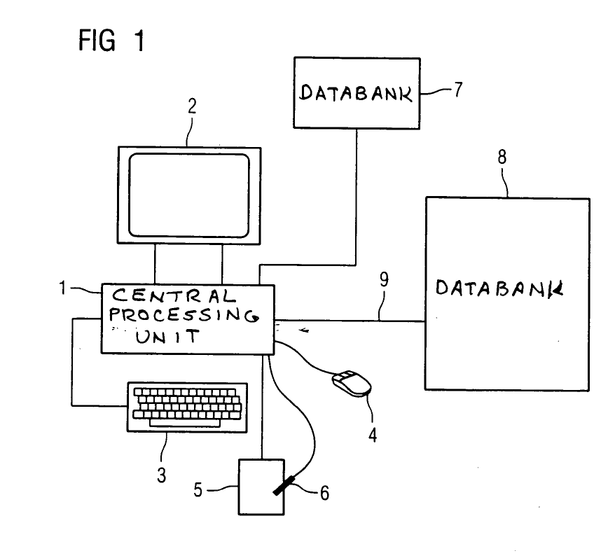

FIG. 1 schematically shows the assembly of an inventive device, which has a central processing unit 1 as a core component of a computer with a monitor 2 and a keyboard 3. The central processing unit 1 not only can be controlled via the keyboard 3, but rather also, for example, via a mouse 4 or via a graphic tablet 5 with a stylus 6.

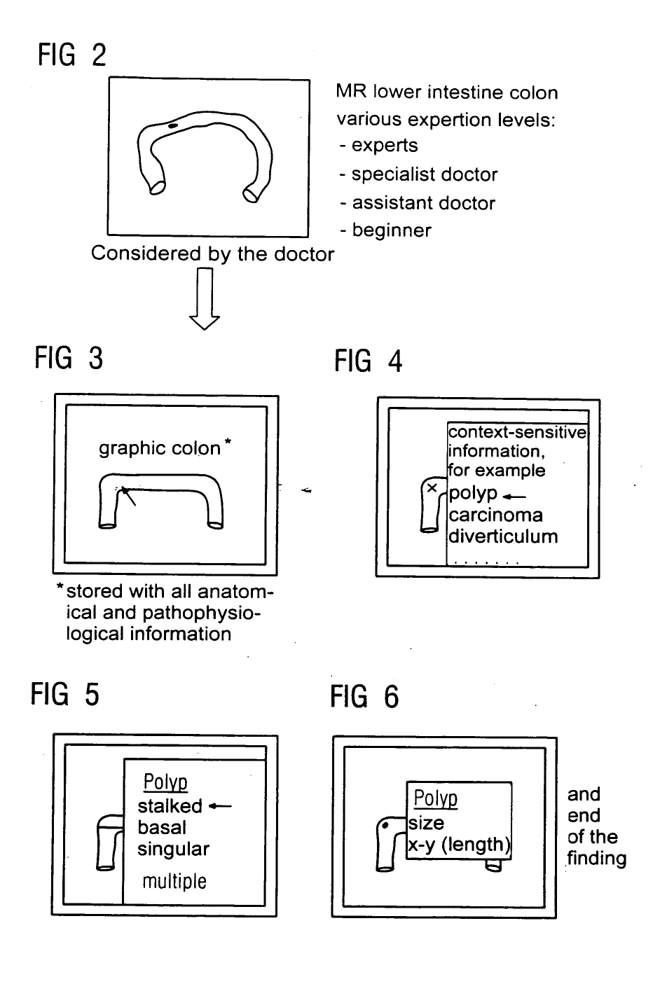

The central processing unit 1 has access to a databank 7 in which the images acquired in the clinical examination with various imaging modalities are stored, on the basis of which a doctor wants to make an evaluation. The central processing unit 1 also has access to with an external databank 8. This contains a hierarchy of finding parameters, sorted according to anatomical localization, findings that can be associated with this anatomical localization to lead toward a (tentative) diagnosis. The anatomical localization images in the databank 8 are modules representing respective body parts, as shown in detail in FIGS. 2 through 9. The connection line 9 between the central processing unit 1 of the computer and the external databank 8 simultaneously forms the interface to call up the modular localization images from this databank for display on the monitor 2.

FIG. 2 schematically shows the clinical image that is provided to the doctor as an x-ray image or an image from another imaging modality for examination of the colon. A doctor makes a finding based on this image. The doctor may have a level of expertise ranging from that of a specialist to that of a general practitioner to that of an intern. After transmission of the finding by the doctor changed parameter sets are provided by the system as a response to this input by the finding doctor as shown in FIG. 3. FIG. 3 illustrates a computer evaluation shown on the screen of the monitor 2, whereby a modular graphic of the colon is shown in which the finding doctor can, for example, click on the appropriate position of a detected tumor-like image. Context-dependent information is thereupon offered to the doctor by the system via the structured databank, such as, for example, the terms “polyp”, “carcinoma”, “diverticulum”, etc., since the body part graphics are stored in this databank with all anatomical and pathophysiological information (FIG. 4).

If the doctor clicks on the word “polyp”, based on the finding detected by the doctor in FIG. 2, a further parameter set is presented to the doctor by the system, as shown in FIG. 5, as the example of a stalked polyp. It is thereupon asked by the computer what size (meaning length×width) this stalked polyp has, and subsequently the finding inquiry is concluded in the exemplary embodiment. A finding is then automatically generated with an automatic finding description in text form, for example singular polyp, stalked, right flexure of the colon with size x . y, etc.

Moreover, additional recommendations and therapy steps are incorporated into the finding, and if necessary a doctor letter is automatically generated in order to relay the standardized finding to a general practitioner or to another medical location.

In connection with the steps according to FIG. 4 through 6, a database can be provided with standardized terminology in the inventive device, for example stored in the databank 8. The standardized terminology can be, for example the specialist's organization for gastroenterology, and consequently the device can generate the evaluation according to this specialized terminology. This enables a substantially better evaluation of a doctor letter by third parties, as is the case when the doctor (as is generally customary) formulates the finding according to his or her personal style, whereby an experienced doctor uses different technical terms in the description of specific objective findings and also localizations, which may not always be correctly recognized in the same manner by other doctors.

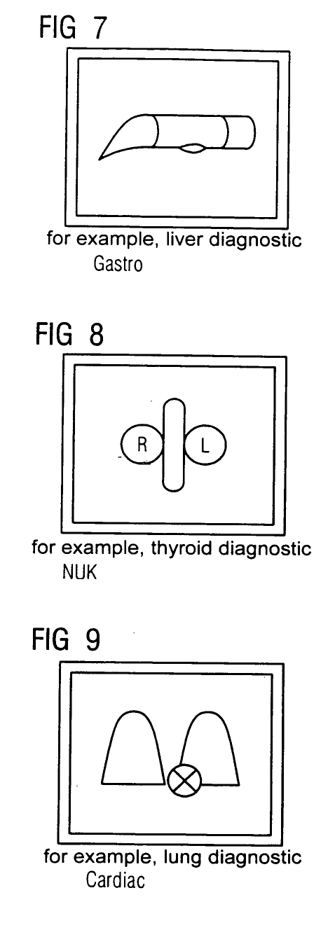

FIG. 7 through 9 respectively are schematic representations of a modular system for a liver diagnostic (gastro), a thyroid diagnostic (NUK), or a lung diagnostic (cardiac). In these cases, the modules are also again known:

suitable anatomical region and details

standardized terminology depending on the department

assignment data

patient data

suitable recommendations/therapy possibilities

logical decision trees, for example finding in the colon, for example tumor→automatic recommendation for metastases search.

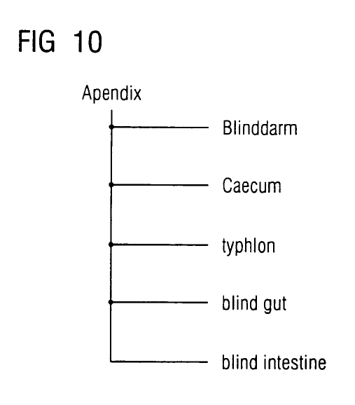

FIG. 10 schematically shows an example for the library with subject terms in which, for example, the term “appendix” is shown. In addition to the German expression “Blinddarm” and the Latin expression “caecum”, there are thereby a series of further foreign-language designations for this body part with descriptions, such that the finding doctor, depending on his or her style and other requirements, can decided on an adequate formulation of the technical expression in the respective finding. The doctor thus, for example, can dictate his or her finding from beginning to end in German technical expressions, or if necessary in varying technical expressions from other languages, and then at the end give the instruction that throughout Latin designations or English designations should be selected, which can be initiated by the central processing unit 1 of the computer based on the technical term library without further action.

Although modifications and changes may be suggested by those skilled in the art, it is the intention of the inventors to embody within the patent warranted hereon all changes and modifications as reasonably and properly come within the scope of their contribution to the art.

We claim as our invention:

1. A device for standardized and digitized generation of medical findings comprising:
a databank in which a plurality of anatomical localization images are stored and in which evaluation parameters respectively associated with the anatomical localization images are stored sorted hierarchically and according to the respective anatomical localizations in the anatomical localization images;
a display monitor;
an evaluation system having access to said databank and connected to said display monitor;
an input unit connected to said evaluation system; and
said evaluation system being supplied with a clinical image of anatomy of a subject and automatically retrieving one of said anatomical localization images from said databank corresponding to said anatomy in said clinical image and automatically displaying one of said anatomical localization images on said display monitor together with text representing a medical finding in a standardized form appropriate for said anatomy in said clinical image, dependent on said evaluation parameters and dependent on information specific to said subject entered into said evaluation system via said input unit.

2. A device as claimed in claim 1 wherein said databank contains data representing said anatomical localization images as modules respectively representing different body parts.

3. A device as claimed in claim 1 comprising a user-operable graphical interface allowing a user to interact with said one of said anatomical localization images on said display monitor to make a designation in said one of said anatomical localization images on said display monitor, and wherein said evaluation unit uses said designation to generate said medical finding in said standardized form.

4. A device as claimed in claim 1 further comprising a memory accessible by said evaluation system containing at least one medical dictionary containing data representing text for medical terms, and wherein said evaluation unit generates said medical finding in said standardized form using said medical terms in said medical dictionary.

5. A device as claimed in claim 4 wherein said memory contains a plurality of medical dictionaries in respectively different languages, and wherein said input unit allows a user to select one of said languages, and wherein said evaluation unit automatically generates said medical finding in said standardized form using medical terms in said selected language.

6. A device as claimed in claim 5 wherein said evaluation unit automatically generates a physician's report, as an evaluation of said clinical image, embodying said medical finding in said standardized form using said medical terms in said selected language.

7. A device as claimed in claim 1 comprising a memory accessible by said evaluation system in which previous medical findings for said subject generated by said evaluation system are stored, and wherein said input unit allows a user to retrieve at least one of said previous medical findings from said memory for comparison with a current medical finding generated by said evaluation system for said subject.

8. A device as claimed in claim 7 wherein said evaluation system automatically generates a delta report identifying differences between said current medical finding and said at least one of said previous medical findings.

9. A device as claimed in claim 1 wherein said evaluation system contains stored, standardized guidelines, and wherein said input unit allows a practitioner to enter data for generating a physician's report embodying said medical finding in said standardized form, and wherein said evaluation system compares said data to said standardized guidelines.

10. A device as claimed in claim 9 further comprising an accounting system connected to said evaluation system for generating an invoice for evaluation of said clinical image, and wherein said evaluation system allows said invoice to be generated only if said data in said physician's report conforms to said standardized guidelines.
